(19) United States
(12) Patent Application Publication
(10) Pub. No.: US 2004/0134231 A1
(43) Pub. Date: Jul. 15, 2004

(54) Liquid crystal display unit-use glass substrate and method of producing mother glass and mother glass inspection device

(76) Inventor: Yoshitaka Oya, Kanagawa-ken (JP)

Correspondence Address: Oliff & Berridge, PO Box 19928, Alexandria, VA, 22320, US

(21) Appl. No.: 10/475,330

(22) PCT Filed: Apr. 2, 2003
(86) PCT No.: PCT/JP03/04216

(30) Foreign Application Priority Data
Apr. 3, 2002 (JP) 2002101593

(51) Int. Cl. C03B 1/00

(52) U.S. Cl. 65/29.11; 65/158

(57) ABSTRACT

Enhancement in yield of production of mother glass and glass substrates for a liquid crystal display device is made possible to make it possible to utilize glass resources more effectively, and reduction of cost of the mother glass and the glass substrate for the liquid crystal display devices is made possible.

A manufacturing method of mother glass for manufacturing mother glass satisfying a predetermined quality standard by manufacturing the mother glass, from which glass substrates for a liquid crystal display device can be cut out according to predetermined cutting-out arrangement information and obtained, and by screening the mother glass, the method has a defect measuring step S2 of measuring a defect existing in the aforesaid manufactured mother glass and obtaining defect information including positional information of the defect, and a defect evaluating step S3 of evaluating quality information determined from the aforesaid defect information and the aforesaid cutting-out arrangement information according to a predetermined evaluation standard, and evaluating quality of the aforesaid mother glass.

### TECHNICAL FIELD

This invention relates to a manufacturing method of glass substrates for a liquid crystal display device for manufacturing glass substrates for a liquid crystal display device by cutting the glass substrates from mother glass according to predetermined cutting-out arrangement information, a manufacturing method of the mother glass, and a mother glass inspection apparatus.

### BACKGROUND ART

In recent years, liquid crystal display devices (liquid crystal panels) used for the display devices of personal computers, and the like tend to have large areas. Demand for reduction in the cost of liquid crystal panels grows more and more as liquid crystal televisions and the like are coming into widespread use, and reduction in cost is also increasingly demanded of glass substrates for liquid crystal display devices that are used for the liquid crystal panels.

A glass substrate for a liquid crystal display device used for the liquid crystal display device is generally produced by being cut into a size as the glass substrate for the liquid crystal display device constituting the individual liquid crystal display device from mother glass that is a glass substrate in a large size in which a plurality of glass substrates for the liquid crystal display device can be arranged, according to predetermined cutting-out arrangement information (layout information).

In this case, as a manufacturing method of the liquid crystal display device, a method of previously mounting a plurality of display circuits at predetermined spots on mother glass in the state before glass substrates for a liquid crystal display device are cut out and thereafter cutting them out is adopted, other than a typical method of previously cutting out the glass substrates for the liquid crystal display devices constituting individual liquid crystal display devices and then mounting switching elements and electrodes such as a TFT, display circuits such as a black mask and the like on these substrates.

Here, if a defect such as a large bubble or a flaw exists in the mother glass, it becomes a fault when it is used as a liquid crystal display device. Due to this, a defect in the mother glass is conventionally measured at the stage of the mother glass, and inspection is performed to determine whether there is a defect likely to be the fault as described above. When a large defect is found even at one spot in the mother glass by the defect inspection of the mother glass in the prior arts, the mother glass is discarded as a defective item.

However, as the area of mother glass that is manufactured becomes larger, the rate of occurrence of a defect to one sheet of mother glass becomes higher generally. Due to this, if the determination is made based on the determination of a defective product and non-defective product of the mother glass as in the prior arts, there arises the problem that the defective rate of the mother glass becomes extremely high as the area of the aforementioned glass substrate for liquid crystal becomes large.

Following the increase in the area of the glass substrate for the liquid crystal, the mother glass with a large area tends to be used, and therefore there also arises the problem that the amount of the glass discarded increases following the defect of one sheet of mother glass and therefore the glass resources cannot be utilized effectively. These problems increase the cost of the mother glass, and causes increase in the cost of the liquid crystal panel as a result.

The present invention is made in the aforementioned background, and has its object to make it possible to enhance yield of production of mother glass and glass substrates for a liquid crystal display device to make it possible to utilize the glass resources effectively, and to make it possible to reduce the cost of the mother glass and the glass substrates for the liquid crystal display device.

### DISCLOSURE OF THE INVENTION

As a method to solve the aforementioned problems, a first aspect of the invention is a manufacturing method of mother glass for manufacturing mother glass satisfying a predetermined quality standard by manufacturing the mother glass, from which glass substrates for a liquid crystal display device can be cut out according to predetermined cutting-out arrangement information and obtained, and by screening the mother glass, and is the manufacturing method of the mother glass comprising:

measuring a defect existing in the aforesaid manufactured mother glass and obtaining defect information including positional information of the defect; and

evaluating quality information determined from the aforesaid defect information and the aforesaid cutting-out arrangement information according to a predetermined evaluation standard, and evaluating quality of the aforesaid mother glass.

A second aspect of the invention is a manufacturing method of glass substrates for a liquid crystal display device for manufacturing glass substrates for a liquid crystal display device by cutting out the glass substrates from mother glass satisfying a predetermined quality standard according to predetermined cutting-out arrangement information, and is the manufacturing method of the glass substrates for the liquid crystal display device comprising:

measuring a defect existing in the aforesaid mother glass and obtaining defect information including positional information of the defect, before cutting the aforesaid mother glass;

evaluating quality information determined from the aforesaid defect information and the aforesaid cutting-out arrangement information according to a predetermined evaluation standard, and evaluating quality of the aforesaid mother glass; and

cutting only the mother glass determined as good in the aforesaid defect evaluating step to obtain the glass substrates for the liquid crystal display device.

A third aspect of the invention is

a mother glass inspection apparatus used when mother glass satisfying a predetermined quality standard is obtained by manufacturing and inspecting the mother glass from which glass substrates for a liquid crystal display device can be cut out according to predetermined cutting-out arrangement information and obtained, and is the mother glass inspecting apparatus comprising:

a defect measuring device which measures a defect existing in the aforesaid manufactured mother glass and obtains defect information including positional information of the defect; and

a defect evaluating device which evaluates quality information determined from the aforesaid defect information and the aforesaid cutting-out arrangement information according to a predetermined evaluation standard and evaluates quality of the aforesaid mother glass.

### BRIEF DESCRIPTION OF THE DRAWINGS

FIG. 1 is a flow chart showing a manufacturing method of a liquid crystal display device with use of a manufacturing method of glass substrates for liquid crystal and a manufacturing method of mother glass according to an embodiment of the present invention;

FIG. 2 is a block diagram showing a constitution of an inspection apparatus for mother glass according to the embodiment of the present invention;

FIG. 3 is an explanatory view of the manufacturing method of the glass substrates for the liquid crystal and the manufacturing method of the mother glass according to the embodiment of the present invention;

FIG. 4 is an explanatory view of the manufacturing method of the glass substrates for the liquid crystal and the manufacturing method of the mother glass according to the embodiment of the present invention; and

FIG. 5 is an explanatory view of the manufacturing method of the glass substrates for the liquid crystal and the manufacturing method of the mother glass according to the embodiment of the present invention.

1 . . . DEFECT INSPECTING SECTION, 2 . . . DEFECT DATA PROCESSING SECTION, 3 . . . DEFECT DATA STORING SECTION, 4 . . . DEFECT INFORMATION EVALUATING PROCESSING SECTION, 5 . . . STORING SECTION, 10 . . . MOTHER GLASS

### BEST MODE FOR CARRYING OUT THE INVENTION

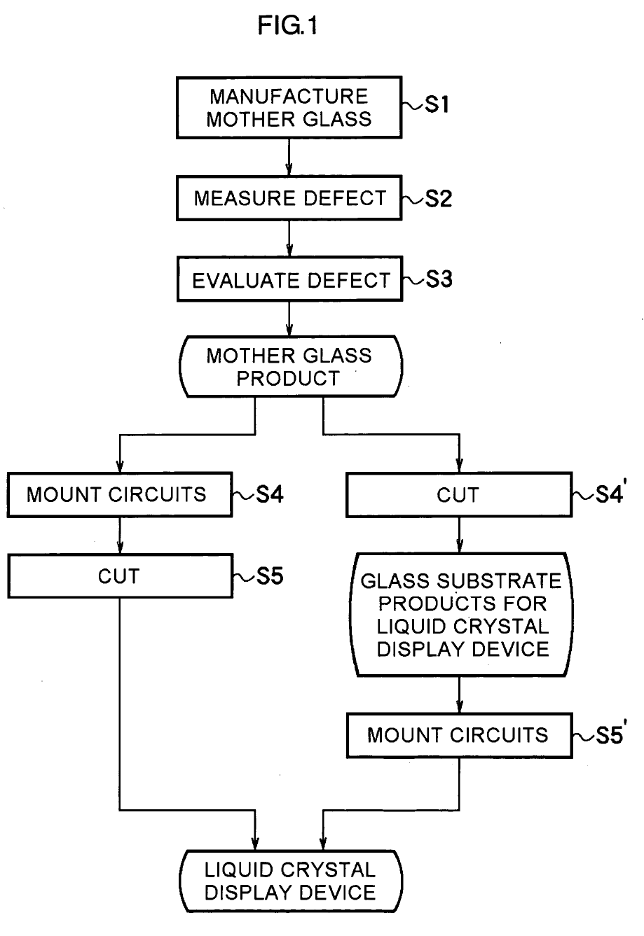

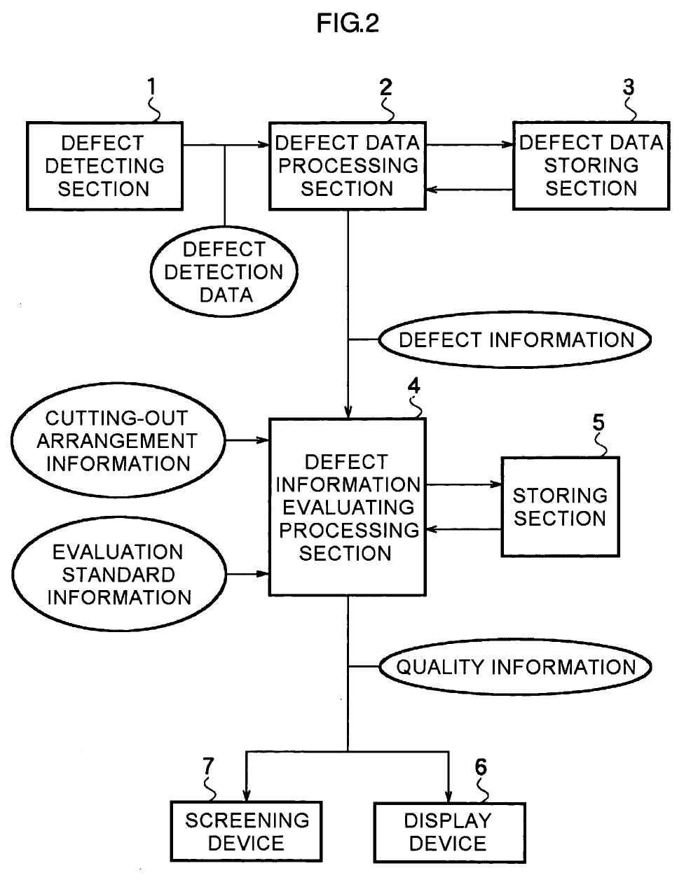

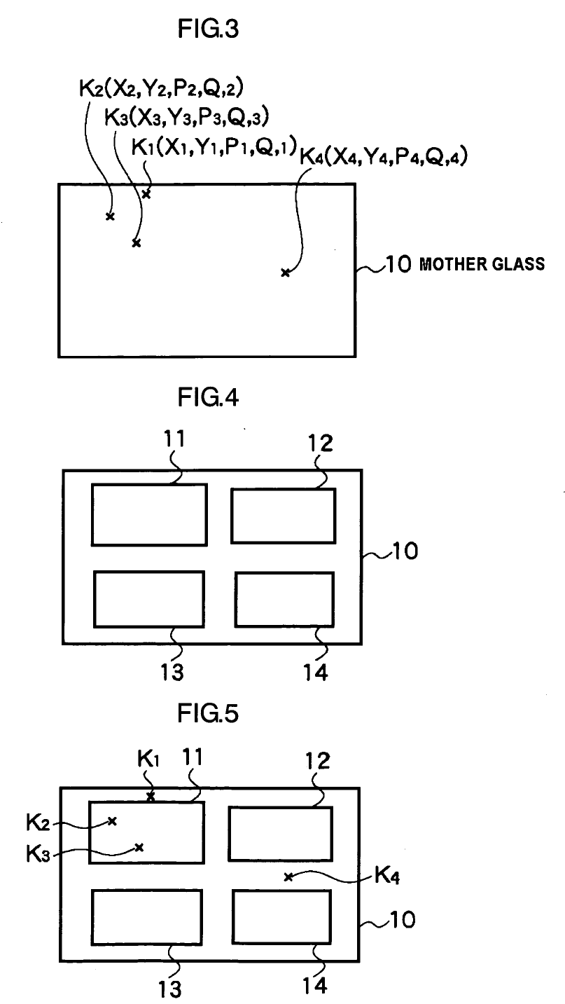

FIG. 1 is a flow chart showing a manufacturing method of a liquid crystal display device using a manufacturing method of glass substrates for liquid crystal and a manufacturing method of mother glass according to an embodiment of the present invention, FIG. 2 is a block diagram showing a constitution of an inspection apparatus for the mother glass according to the embodiment of the present invention, and FIG. 3 to FIG. 5 are explanatory views of the manufacturing method of the glass substrates for liquid crystal and the manufacturing method of the mother glass according to the embodiment of the present invention. Hereinafter, the manufacturing method of glass substrates for liquid crystal, the manufacturing method of the mother glass and the inspection apparatus for the mother glass according to the embodiment of the present invention will be explained with reference to these drawings.

As shown in FIG. 1, in the manufacturing method of the liquid crystal display device according to this embodiment, after the mother glass is manufactured and a defect is inspected, a plurality of circuits are mounted on the mother glass first and thereafter the mother glass is cut to obtain the liquid crystal display device, or after the mother glass is cut and the glass substrates for the liquid crystal display device are produced, the circuits are mounted on the individual substrates to obtain the liquid crystal display device, and the manufacturing method of the liquid crystal display device has a mother glass manufacturing step S1, a defect measuring step S2, a defect evaluating step S3, a circuit mounting step S4 or a cutting step S4′, and a cutting step S5 or a circuit mounting step S5′. These steps will be explained hereinafter.

(1) Mother Glass Manufacturing Step S1

Here, the mother glass is a glass plate from which the glass substrates for the liquid crystal display device can be obtained by being cut out according to predetermined cutting-out arrangement information (layout). The cutting-out arrangement information is layout information to cut out a plurality of substrates in the size as the glass substrates for the liquid crystal display device which constitute the individual liquid crystal display devices from the mother glass that is the large-sized glass substrate on which a plurality of glass substrates for the liquid crystal display device can be placed.

As for manufacturing of the mother glass, it is obtained by cutting a large-sized plate glass, which is manufactured by a float method, a down draw method and the like that are the known plate glass manufacturing method, into a predetermined size. The down draw method is a method for forming a plate glass by continuously supplying molten glass from a dissolver along a die surface, and after fusing the glass on both sides under a forming die, drawing a perimeter portion of the glass downward by a roller or the like (Refer to Japanese Patent Laid-open No. Hei 10-291826 and the like for further information).

According to the above manufacturing methods, large-sized plate glass, for example, 1 m×1 m in the length and width measurements, and 0.7 mm in thickness is obtained. This plate glass is cut into a small size of 550×650 mm, or 600×720 mm or the like, whereby the mother glass for the glass substrates for the liquid crystal display devices are manufactured. As a glass substrate for a liquid crystal display device, there are a glass substrate for a TFT with a TFT (thin film transistor) being formed on the substrate surface, a glass substrate for a color filter, and the like. In the TFT glass substrate, a circuit such as a thin film transistor is formed on the glass substrate, while in the glass substrate for a color filter, each color filter is individually formed on the glass substrate. These substrates with the thin film hold the liquid crystal, whereby the liquid crystal display device (liquid crystal device) is manufactured.

(2) Defect Measuring Step S2

Next, a defect is measured for the mother glass manufactured in the above-described mother glass manufacturing step. The defect mentioned here is the defect having the possibility of affecting the property which is necessary for the use purpose of the glass substrate for the liquid crystal display device. In concrete, a bubble existing in the mother glass, a flaw, a point defect, contamination, adhesion of foreign matters and the like are cited. In the defect measuring step S2, such defects are detected, and the detection data is processed, whereby the information such as the kinds, positions (X-coordinate, Y-coordinate), and size of these defects is obtained as defect information.

The defect information is obtained by using the inspection apparatus for the mother glass as shown in FIG. 2. The mother glass inspection apparatus has a defect detecting section 1, a defect data processing section 2, a defect data storing section 3, a defect information evaluating processing section 4, a storing section 5, a display device 6 and a screening device 7.

As the defect detecting section 1, a defect detecting device utilizing a method for detecting a defect in the glass substrate by making light incident on the glass substrate, detecting the light reflected or scattered by a defect existing in the substrate, and measuring the transmittance and the reflectivity at each point on the glass substrate is used. As such a device, a device utilizing a method of making light incident on the substrate surface and scanning it as disclosed in, for example, Japanese Patent Publication No. Shou 57-37023, and a device utilizing a method of making light incident on the side surface of the substrate as disclosed in Japanese Patent Laid-open No. Hei 8-261953 can be used.

The defect data processing section 2 creates defect information by processing the defect data obtained in the defect detecting section 1. In this case, the defect data obtained in the defect detecting section 1 is the data obtained as two-dimensional image data by scanning the mother glass by a line sensor. This data is temporarily stored in the defect data storing section 3, and sequentially read out and processed according to a fixed processing standard by the defect data processing section. According to this, the defect information indicating the kind of the defect, position (X-coordinate, Y-coordinate), size and the like is created from this defect data.

The created defect information is the information peculiar to each of the measured mother glass, and therefore the defect information is given identifying information to identify each specific mother glass. At the same time, the identifying information is cut in the mother glass itself as an identifying label. As a method for giving the identifying mark to the mother glass, for example, a method of baking a two-dimensional code on an area near a perimeter of the mother glass by using laser light, and the like are cited. In this case, the laser light is brought into focus at a region located inside the glass by a predetermined distance from the glass surface to stipple, whereby the two-dimensional code can be marked as the identifying label without giving a damage onto the glass surface.

(3) Defect Evaluating Step S3

Next, after the defect information obtained in the above-described defect measuring step is stored in the storing section 5, it is read out sequentially and evaluated in the defect evaluating step S3, and the quality of the mother glass is determined. The defect information evaluating processing is performed by the defect information evaluating processing section 4 in the defect inspection apparatus in FIG. 2. The defect information evaluating processing section 4 inputs therein the defect information sent from the defect data processing section 2, the cutting-out arrangement information and the evaluation standard information, which are created based on the specification of the customer and the like, and adds a fixed processing to create the quality information.

FIG. 3 is an explanatory view showing the defect information. FIG. 3 shows a case in which four defects, K1, K2, K3 and K4 are detected inside a mother glass 10. The defect information is constituted of X-coordinates (X1, X2, X3, and X4) and Y-coordinates (Y1, Y2, Y3, and Y4), which show the positions of the defects, symbols indicating the kinds of the defects (P1, P2, P3 and P4), symbols indicating the sizes of the defects (Q1, Q2, Q3, and Q4), for the respective four defects. As this defect information, the other information regarding the defects may be included other than the positions of the defects, the kinds of the defects and the sizes of the defects.

FIG. 4 is an explanatory view showing the cutting-out arrangement information (layout information). The cutting-out arrangement information is the layout information how a plurality of glass substrates for the liquid crystal display device are cut out from one sheet of the mother glass 10. In the case of FIG. 4, it shows a case in which four of the glass substrates 11, 12, 13 and 14 for the liquid crystal display device are cut out from one sheet of the mother glass 10. The layout information when such glass substrates for the liquid crystal display device are cut out is determined correspondingly to the size and the number of the glass substrates for the liquid crystal display device. When the mother glass is delivered to the customer, the layout information designated by the customer is used.

The evaluation standard information is created for each kind of cutting-out arrangement information. Namely, when the cutting-out arrangement information as shown in FIG. 4 is specified, the evaluation standard information corresponding to it is selected. The standard has the determined standard values on a pass/fail basis, or of ranking, concerning, for example, what position of the area divided based on the cutting-out arrangement information a defect is located at, or, what kind of defect the defect is, or in what size the defect is, how many defects exist, and the like.

In the defect information evaluating processing section 4, the sent defect information (the size, the position and the kind of the defect) is checked against the standard determined as described above, and the processing of the determination of pass or fail, or the ranking is performed. FIG. 5 is an explanatory view of the defect information evaluating processing. As shown in FIG. 5, the processing can be performed by utilizing a method and the like of superimposing or overlaying processing of, for example, the defect information image shown in FIG. 3 and the cutting-out arrangement information image shown in FIG. 4, and simulating what kind of defect in what size is placed at what position inside or outside the area divided based on the cutting-out arrangement information.

In the example shown in FIG. 5, the defects K1 and K4 are in the area outside the area which is cut out as the glass substrates for the liquid crystal display. Accordingly, these defects are not regarded as defects. On the other hand, the defects K2 and K3 are inside the area which is cut out as the glass substrate 11 for the liquid crystal display. Therefore, the kinds and the sizes of these defects K2 and K3 are checked against the standard, next. As a result, if they are the defects deviated from the standard, the area which is cut out as the glass substrate 11 for the liquid crystal display is evaluated as unusable. Conversely speaking, the mother glass 10 is evaluated as having the quality to make it possible to cut out three glass substrates for the liquid crystal display.

The defect information of a plurality of sheets of mother glass, a plurality of different pieces of cutting-out arrangement information and each evaluation standard information are stored in the storing section 5 of the defect information evaluating processing section 4 in FIG. 2, and the combination of these pieces of information is sequentially changed and the aforementioned simulation method is repeated, whereby the combination by which the largest number of glass substrates for the liquid crystal display device can be cut out can be found. According to this, effective use of glass resources is improved more, and further cost reduction can be realized. According to the above, the mother glass products evaluated in quality can be obtained.

The quality information thus obtained is sent to the display device 6, the screening device 7 or the like. In the display device 6, the image as shown in FIG. 5 is displayed by a display or the like, or the information is displayed by being printed as an image or numeral values with a printer or the like. In this case, in addition to the positional information of the defect, the information such as the kind and the size of the defect can be displayed on the mother glass image. For example, the size of the defect can be shown by the size of the point indicating the defect, and the kind of the defect can be shown by changing the colors according to the kinds. They may be displayed as necessary based on the defect information, but it is generally determined roughly according to the kind and the size of the defect whether it is a serious defect or not, and therefore it is preferable to display the information of the kind and the size in addition to the positional information of the defect. In the screening device 7, an operation and the like of classifying the sheets of the mother glass on a pass/fail basis or quality ranking basis based on the above-described quality information are performed.

Next, the liquid crystal display device is manufactured by using the mother glass product thus obtained, and there are two kinds of manufacturing steps. Namely, there are the case in which after the step S4 of mounting the circuits directly on the mother glass is performed, the cutting process S5 is performed to obtain the liquid crystal display device, and the case in which after the step S4′ of cutting out the mother glass and obtaining the glass substrates for the liquid crystal display device is performed, the step S5′ of mounting the circuits on the individual glass substrates for the liquid crystal display device is performed. Thereafter, by performing a known step, the glass substrate with a TFT, the glass substrate with a color filter and the like are obtained, and the liquid crystal display device (liquid crystal device) is obtained.

According to the aforementioned embodiment, the following advantages are provided. Namely, in the prior arts, the defect information of the specified mother glass and the predetermined layout are not linked, and therefore even when the defects are outside the layout as described above, the mother glass is discarded as a defective product, but according to the present invention, it becomes possible to use this as a good product.

The case in which the defects exist inside the layout will be as follows. For example, when defects are only in one of the layout of four of the liquid crystal glass substrates to be produced, the area of one glass substrate having the defects does not meet the required specification, but the area corresponding to the other three glass substrates meets the required specification. In such a case, only the area corresponding to the usable three glass substrates is used effectively, whereby the mother glass can be utilized without discarding the entire mother glass. In the prior art, the above mother glass is all discarded as the mother glass having defects as in the case of the defects outside the aforementioned layout, but according to the present invention, the relation of the layout can be known in advance, and it becomes possible to utilize the usable area effectively instead of discarding the mother glass, thus making it possible to utilize the glass resources effectively.

One glass substrate for the liquid crystal display device produced from the area corresponding to the defects is likely to be a defective product due to the defects of the base plate glass in the end, but according to the placement of a TFT, a color filter, a black mask and the like, it is likely to be usable even if it is the area including the defects as described above. The determination whether the mother glass including defects in the layout as described above is a good product or a defective product is made in the relation with the manufacturer of the glass substrates for the liquid crystal display device. For example, when the mother glass is delivered to the customer who manufactures the glass substrates for the liquid crystal display device, if the consent is obtained after the defect information of the mother glass is previously notified, the mother glass can be delivered without discarding it as a defective product.

Switching elements and electrodes of the TFT and the like, a black mask and the like are formed at predetermined positions as necessary on the mother glass which is not discarded but delivered. The mother glass on which the switching elements and the electrodes are thus formed is cut according to the predetermined layout, whereby the glass substrates for the liquid crystal display device can be obtained. The glass substrates in the size of the final product are cut out of the mother glass in advance, and thereafter, the switching elements and electrodes of the TFT or the like, the black mask and the like may be formed on the cut substrates. Alternatively, after the mother glass is divided into several parts in advance, the elements are formed on the divided base plate, and thereafter, the final glass substrates for the liquid crystal display device may be cut out from the divided base plate.

As described above, in the present invention, by previously linking the defects existing in the specified mother glass and the cutting-out layout of the glass substrates for the liquid crystal display device to be cut from the mother glass, it is made possible to effectively utilize even the mother glass including a defect inside the layout not to say the mother glass having a defect outside the layout. In the prior arts, no attention is paid to the relation between the individual mother glass and the cutting-out layout of the glass substrates for the liquid crystal display device, and therefore the mother glass only having the defect outside the layout and is usable without a problem is discarded only because it has the serious defect. Even the mother glass having the other usable area is all discarded only because it has a defect inside the layout. On the other hand, according to the present invention, the mother glass which is conventionally discarded can be utilized effectively.

### INDUSTRIAL AVAILABILITY

As described in detail thus far, the present invention has the defect evaluating step of evaluating the quality information determined from the defect information and the cutting-out arrangement information according to the predetermined evaluation standard to evaluate the quality of the mother glass, whereby it is made possible to enhance yield of production of mother glass and the glass substrates for the liquid crystal display device to make it possible to utilize the glass resources more effectively, and it is made possible to reduce the cost of the mother glass and the glass substrates for the liquid crystal display device.

1. A manufacturing method of mother glass for manufacturing mother glass satisfying a predetermined quality standard by manufacturing the mother glass, from which glass substrates for a liquid crystal display device can be cut out according to predetermined cutting-out arrangement information and obtained, and by screening the mother glass, said method comprising:
measuring a defect existing in said manufactured mother glass and obtaining defect information including positional information of the defect; and
evaluating quality information determined from said defect information and said cutting-out arrangement information according to a predetermined evaluation standard, and evaluating quality of said mother glass.

2. A manufacturing method of glass substrates for a liquid crystal display device for manufacturing glass substrates for a liquid crystal display device by cutting out the glass substrates from mother glass satisfying a predetermined quality standard according to predetermined cutting-out arrangement information, said method comprising:
measuring a defect existing in said mother glass and obtaining defect information including positional information of the defect, before cutting said mother glass;
evaluating quality information determined from said defect information and said cutting-out arrangement information according to a predetermined evaluation standard, and evaluating quality of said mother glass; and
cutting only the mother glass determined as good in said defect evaluating step to obtain the glass substrates for the liquid crystal display device.

3. A mother glass inspection apparatus used when mother glass satisfying a predetermined quality standard is obtained by manufacturing and inspecting the mother glass from which glass substrates for a liquid crystal display device can be cut out according to predetermined cutting-out arrangement information and obtained, said apparatus comprising:
a defect measuring device which measures a defect existing in said manufactured mother glass and obtains defect information including positional information of the defect; and
a defect evaluating device which evaluates quality information determined from said defect information and said cutting-out arrangement information according to a predetermined evaluation standard and evaluates quality of said mother glass.
